(19) United States
(12) Patent Application Publication
(10) Pub. No.: US 2026/0049198 A1
(43) Pub. Date: Feb. 19, 2026

(54) PROCESSES FOR RECYCLING COMPOSITE MATERIALS

(71) Applicant: Westlake Epoxy Inc., Houston, TX (US)

(72) Inventors: Gunda KUHLMANN, Hamm (DE); Claudia REMUS, Rheinberg (DE); Christoph SCHÄDLE, Geislingen (DE); Gabriele BADINI, Dusseldorf (DE)

(21) Appl. No.: 19/265,341

(22) Filed: Jul. 10, 2025

Related U.S. Application Data
(60) Provisional application No. 63/682,772, filed on Aug. 13, 2024.

(51) Int. Cl. C08J 11/28

(52) U.S. Cl. CPC C08J 11/28; C08J 2363/00; C08J 2367/06

(57) ABSTRACT

Embodiments of the present disclosure generally relate to processes for recycling a composite material. In an embodiment is provided a process for recycling a composite material. The process includes reacting a mixture comprising an amine and a composite material comprising reinforcement material and a cured thermosetting resin matrix to form a reaction product mixture. The process further includes isolating the reinforcement material from the reaction product mixture and isolating an organic liquid composition comprising degraded residues from the reaction product mixture. The reinforcement material and organic liquid composition isolated may be re-used to make new materials.

### CROSS-REFERENCE TO RELATED APPLICATIONS

This application claims benefit of and priority to U.S. Provisional Patent Application No. 63/682,772, filed on Aug. 13, 2024, which is incorporated herein by reference in its entirety.

### FIELD

Embodiments of the present disclosure generally relate to processes for recycling a composite material.

### BACKGROUND

Composite materials are used extensively in applications where improved properties and reduced weight are required, such as in the aerospace, automobiles, civil infrastructures, and sports goods industries, as well as in the renewable energy space such as the construction of wind-turbine blades. The light weight and improved properties of composite materials rely on integrating reinforcement materials, such as fibers, into a cured thermosetting resin matrix (an organic matrix). As new and more effective composite materials are used for industrial and consumer products, concerns about waste disposal of composite materials have increased. In addition, the integration of reinforced materials in the cured thermosetting resin matrix poses disposal, recycling, and re-use challenges, and there are a limited number of sustainable end-of-life solutions available for composite materials.

Conventional technologies for composite material recycling rely on mechanical, thermal, and solvolysis processes to reclaim valuable materials from the used composite material, but suffer from inefficiencies, waste, and lack circularity. For example, conventional mechanical mastication and pyrolytic isolation do not efficiently enable the recovery of the organic matrix, and instead focus on the quality of reinforcement materials recovered. Even so, the high temperatures employed with pyrolysis leads to diminished mechanical properties of the recovered reinforcement materials.

Conventional solvolysis processes utilize a combination of an organic solvent, such as toluene, to solubilize the organic matrix and either an acid or base to enable chain scission and degradation of the organic matrix. However, the toluene must be removed. Another conventional approach utilizes catalysts and a dissolution medium. For example, recycling of epoxy-anhydride resins is accomplished by immersing the composite material in ethylene glycol, heated, and in the presence of a catalyst, ester bonds of the polymer skeleton are broken; the repolymerization of the decomposed epoxy oligomer occurs via evaporating the excess ethylene glycol. However, this approach is limited by the need of high catalyst concentration (greater than 10 wt %), the need to remove the ethylene glycol dissolution medium after recycling to reuse the recyclate (recycled material). Recyclable epoxy resin systems are also utilized but rely on the recyclability of the curing agent such as recyclamine hardeners. Here, the cured epoxy resin matrix is cleaved to recover fibers and the epoxy matrix as a recyclable thermoplastic. However, as a thermoplastic, the epoxy resin cannot be re-used indicating limited circularity of this conventional technology.

There is a need for new processes for recycling composite materials.

### SUMMARY

Embodiments of the present disclosure generally relate to processes for recycling a composite material. Unlike conventional technologies, embodiments described herein allow recycling and re-use of the components of the composite materials—the reinforcement material and the cured thermosetting resin matrix (or degraded residues thereof). In addition, embodiments described herein may be performed at milder temperatures than conventional approaches and may be free of inefficient solvent recovery operations.

In an embodiment is provided a process for recycling a composite material. The process includes reacting a mixture comprising an amine and a composite material comprising reinforcement material and a cured thermosetting resin matrix to form a reaction product mixture. The process further includes isolating the reinforcement material from the reaction product mixture and isolating an organic liquid composition comprising degraded residues from the reaction product mixture.

In another embodiment, a process for recycling a composite material is provided. The process includes reacting, at a reaction temperature of about 250° C. or less, a reaction mixture comprising an amine and a composite material comprising reinforcement material and a cured thermosetting resin matrix to form a reaction product mixture, the amine comprising at least one primary or secondary amine group, the amine being reactive with the cured thermosetting resin matrix at the reaction temperature. The process further includes isolating the reinforcement material from the reaction product mixture. The process further includes isolating an organic liquid composition from the reaction product mixture, the organic liquid composition comprising degraded residues produced from the reacting the amine and the cured thermosetting resin matrix.

In another embodiment, a process for recycling a composite material is provided. The process includes pretreating a composite material comprising reinforcement material and a cured thermosetting resin matrix, the pretreating comprising: comminuting the composite material; mixing the composite material with a swelling agent; or combinations thereof. The process further includes reacting, at a reaction temperature of about 250° C. or less, a reaction mixture comprising an amine and the pretreated composite material to form a reaction product mixture, the amine comprising at least one primary or secondary amine group, the amine being reactive with the cured thermosetting resin matrix at the reaction temperature. The process further includes isolating the reinforcement material from the reaction product mixture. The process further includes isolating an organic liquid composition from the reaction product mixture, the organic liquid composition comprising degraded residues produced from the reacting the amine and the cured thermosetting resin matrix.

In another embodiment, a process for recycling a composite material is provided. The process includes (a) reacting, at a reaction temperature of about 250° C. or less, a reaction mixture comprising an amine and a composite material comprising reinforcement material and a cured thermosetting resin matrix to form a reaction product mixture, the amine comprising at least one primary amine or secondary amine group, the amine being reactive with the cured thermosetting resin matrix at the reaction temperature. The process further includes (b) isolating the reinforcement material from the reaction product mixture. The process further includes (c) isolating an organic liquid composition from the reaction product mixture, the organic liquid composition comprising degraded residues produced from the reacting the amine and the cured thermosetting resin matrix. The process further includes (d) performing post-treatment processing of the organic liquid composition, the post-treatment processing comprising: introducing an epoxy resin to the organic liquid composition to form adducts with the degraded residues, unreacted amine, or combinations thereof; introducing a curing agent to the organic liquid composition and combine it with an epoxy resin to form a second cured thermosetting resin matrix, the second cured thermosetting resin matrix different from the cured thermosetting resin matrix of the composite material; recycling the organic liquid composition to (a) the reacting the reaction mixture to form the reaction product mixture; or combinations thereof.

In another embodiment is provided a process for recycling a composite material. The process includes reacting a mixture comprising an alkylamine and a composite material comprising reinforcement material and a cured thermosetting resin matrix to form a reaction product mixture. The process further includes isolating the reinforcement material from the reaction product mixture and isolating an organic liquid composition comprising degraded residues from the reaction product mixture.

In another embodiment, a process for recycling a composite material is provided. The process includes reacting, at a reaction temperature of about 250° C. or less, a reaction mixture comprising an alkylamine and a composite material comprising reinforcement material and a cured thermosetting resin matrix to form a reaction product mixture, the alkylamine comprising at least one primary amine group, the alkylamine being reactive with the cured thermosetting resin matrix at the reaction temperature. The process further includes isolating the reinforcement material from the reaction product mixture. The process further includes isolating an organic liquid composition from the reaction product mixture, the organic liquid composition comprising degraded residues produced from the reacting the alkylamine and the cured thermosetting resin matrix.

In another embodiment, a process for recycling a composite material is provided. The process includes pretreating a composite material comprising reinforcement material and a cured thermosetting resin matrix, the pretreating comprising: comminuting the composite material; mixing the composite material with a swelling agent; or combinations thereof. The process further includes reacting, at a reaction temperature of about 250° C. or less, a reaction mixture comprising an alkylamine and the pretreated composite material to form a reaction product mixture, the alkylamine comprising at least one primary amine group, the alkylamine being reactive with the cured thermosetting resin matrix at the reaction temperature. The process further includes isolating the reinforcement material from the reaction product mixture. The process further includes isolating an organic liquid composition from the reaction product mixture, the organic liquid composition comprising degraded residues produced from the reacting the alkylamine and the cured thermosetting resin matrix.

In another embodiment, a process for recycling a composite material is provided. The process includes (a) reacting, at a reaction temperature of about 250° C. or less, a reaction mixture comprising an alkylamine and a composite material comprising reinforcement material and a cured thermosetting resin matrix to form a reaction product mixture, the alkylamine comprising at least one primary amine group, the alkylamine being reactive with the cured thermosetting resin matrix at the reaction temperature. The process further includes (b) isolating the reinforcement material from the reaction product mixture. The process further includes (c) isolating an organic liquid composition from the reaction product mixture, the organic liquid composition comprising degraded residues produced from the reacting the alkylamine and the cured thermosetting resin matrix. The process further includes (d) performing post-treatment processing of the organic liquid composition, the post-treatment comprising: introducing an epoxy resin to the organic liquid composition to form adducts with the degraded residues, unreacted alkylamine, or combinations thereof; introducing a curing agent to the organic liquid composition to form a second cured thermosetting resin matrix, the second cured thermosetting resin matrix different from the cured thermosetting resin matrix of the composite material; recycling the organic liquid composition to (a) the reacting the reaction mixture to form the reaction product mixture; or combinations thereof.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a flowchart showing selected operations of a process for recycling a composite material according to at least one embodiment.

FIG. 2 is a flowchart showing selected operations of a process for recycling a composite material according to at least one embodiment.

FIG. 3 is a generalized schematic flow diagram illustrating various embodiments of processes described herein corresponding to operational areas or units in a composite material processing plant.

FIG. 4 is a generalized schematic flow diagram illustrating various embodiments of processes described herein corresponding to operational areas or units in a composite material processing plant.

### DETAILED DESCRIPTION

Embodiments described herein generally relate to processes for recycling a composite material that includes a reinforcement material and a cured thermosetting resin matrix. Embodiments of the present disclosure enable the isolation of both components making up the composite material—the reinforcement material component and the thermosetting resin matrix component (or degraded residues thereof). Advantageously, both of these components may be re-used. In addition, recycling may be performed at milder temperatures than conventional approaches and may be free of inefficient solvent recovery operations.

The inventors discovered that an amine, such as an alkylamine, may be used to degrade or decompose the cured thermosetting resin matrix. Through contact and reaction of the amine with the cured thermosetting resin matrix, the cured thermosetting resin matrix degrades or decomposes into residues that become solubilized in the resulting reaction product mixture. As another result of the reaction between the amine and the cured thermosetting resin matrix, the reinforcement materials are released from the cured thermosetting resin matrix as solids into the reaction product mixture. The reaction product mixture, which is a suspension or slurry, may then be separated to isolate the solid reinforcement materials from the organic liquid containing the residues.

Embodiments described herein enable the decomposition or degradation of composite materials into reinforcement materials and a useable or recyclable organic liquid composition. As used herein, a “composition” may include component(s) of the composition, reaction product(s) of two or more components of the composition, a remainder balance of remaining starting component(s), or combinations thereof. Compositions of the present disclosure may be prepared by any suitable mixing process.

The organic liquid composition, a recyclate, includes reaction products from reaction, for example, decomposition or degradation, of the cured thermosetting resin matrix with an amine. Following reaction, the organic liquid composition may be separated from the reinforcement material. Both the organic liquid composition and the reinforcement material may be upgraded by further downstream processing. For example, the reinforcement materials obtained by processes described herein may be used to form another composite material, or may be processed into yarn, a woven fabric, a non-woven fabric, pellets, milled pellets, fibers, fillers, a second composite material, or combinations thereof. As another example, the organic liquid composition may be used directly to form another composite material, may be used to form adducts with epoxy resins or the organic liquid composition may be blended with a curing agent. Additionally, or alternatively, a portion of the slurry formed from reaction of the composite material and the amine may be taken, and without separation, used in a variety of applications such as adhesives, insulation materials, coatings, thermoset composites, insulation materials, as well as bulk molding compounds and sheet molding compounds for composite applications such as in the automotive, aerospace, appliance, wind, electrical, or construction industries.

Advantageously, by use of an amine, the degradation or decomposition of the composite material may be performed without the use of solvents as is typically seen with conventional degradation processes including solvolysis. Solvolysis processes require solvent removal via distillation or extraction and also require an acid or base to cause chain scission, or degradation, of the matrix. In addition, processes described herein may be performed at lower temperatures than those observed with conventional technologies such as thermal and solvolysis approaches.

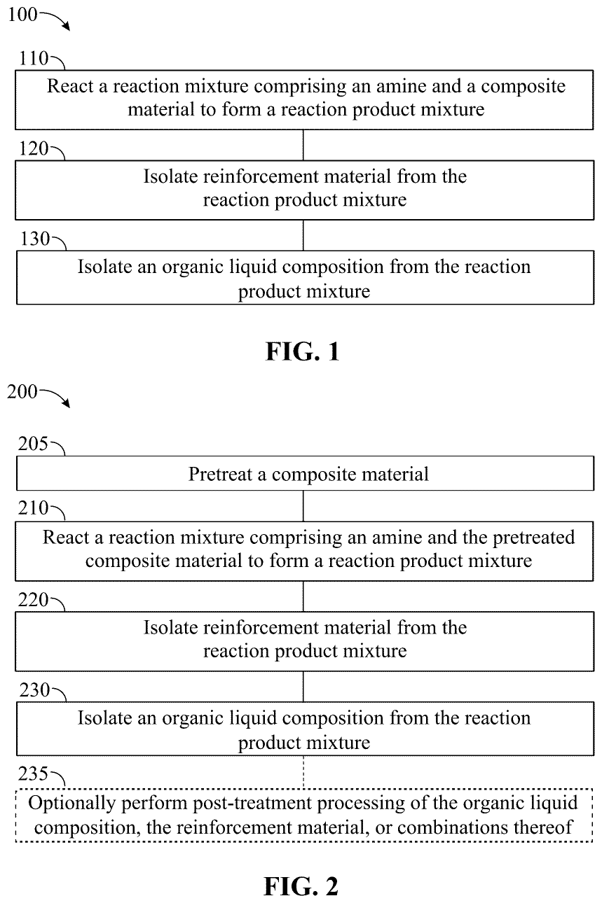

FIG. 1 is a flowchart illustrating a process 100 for recycling a composite material comprising a cured thermosetting resin matrix and a reinforcement material. In general, the process enables separation of the reinforcement material from the cured thermosetting resin matrix, and products from the process may be re-used. Embodiments and implementations of process 100 may be combined with other embodiments described herein.

The process 100 may begin with reacting a reaction mixture comprising an amine and a composite material to form a reaction product mixture at operation 110. Any suitable amine may be used such as those amine that are reactive with the cured thermosetting resin matrix. Suitable amines may include those amines with at least one primary amine group, at least one secondary amine group, or combinations thereof. The amine is reactive with the cured thermosetting resin matrix under reaction conditions of operation 110, such as a reaction temperature. That is, the amine is not simply a solvent in contrast to conventional solvolysis approaches.

The amine may be linear or branched, cyclic or acyclic. The amine may be fully unsaturated, partially unsaturated, or fully saturated. The amine may be a fully saturated acyclic amine, a fully saturated cyclic amine, or combinations thereof. The amine may include one or more primary amine groups, one or more secondary amine groups, or combinations thereof. The amine may include an alkylamine. The amine may include a monoamine (having one amine group), a diamine (having two amine groups), a triamine (having three amine groups), a tetramine (having four amine groups), and so forth, or combinations thereof.

Illustrative, but non-limiting, examples of amines may include, but are not limited to, 2-methylpentane-1,5-diamine (MPDA), hexane diamine, 1,3-bis(aminomethyl)cyclohexane (1,3-BAC), triethylene tetramine, isophorone diamine (IPDA), hexylamine, hexamethyleneimine, or combinations thereof. More than one amine may be utilized for operation 110.

An amine having more than one amine group may be beneficial for reactivity purposes. In addition, and relative to cyclic amines, linear amines may have less steric hindrance and may more easily diffuse into the composite material. As a result, linear amines may be more capable of interacting and reacting with functional group(s) present in the cured thermosetting resin matrix relative to cyclic amines.

Composite materials suitable for use in processes described herein may include a reinforcement material and a cured thermosetting resin matrix. The cured thermosetting resin matrix is a three-dimensional network structure. The reinforcement material is associated with, distributed, or embedded throughout the cured thermosetting resin matrix such that it cannot simply be separated from the cured thermosetting resin matrix without breaking down the cured thermosetting resin matrix in some manner.

The reinforcement material of the composite material may be made from a variety of substances. For example, the reinforcement material may be inorganic, organic, metallic, clay, ceramic, or combinations thereof. The reinforcement material may include glass, carbon, aramid (aromatic polyamide), thermoplastic fibers, natural fibers, inorganic fillers, metals, or combinations thereof. The reinforcement material may be in the form of a fiber, fabric, particle, or combination thereof. In some examples, the reinforcement material includes glass fiber, glass fabric, carbon fiber, carbon fabric, aramid fiber, aramid fabric, or combinations thereof.

The cured thermosetting resin matrix may be derived from a thermosetting resin, a curing agent, an optional reactive diluent, and optionally, one or more additional components. Additionally, or alternatively, the cured thermosetting resin matrix may be derived from a homopolymerization of the thermosetting resin using a Lewis acid (an example curing agent). Additionally or alternatively, the cured thermosetting resin matrix may be derived from polymerization of a vinyl ester, an unsaturated polyester, acrylic resin, or combinations thereof.

Examples of thermosetting resins may include, but are not limited to, epoxy resins, polyester resins, or combinations thereof. Epoxy resins and polyester resins include those which may be cured by suitable curing agents. Combinations of resins may be utilized.

The epoxy resin may be saturated or unsaturated, aliphatic, cycloaliphatic, aromatic or heterocyclic and may be substituted. Epoxy resins may be monomeric or polymeric. Epoxy resins may include those compounds containing at least one vicinal epoxy group. Epoxy resins suitable for use with embodiments described herein may include non-aromatic epoxy resins and aromatic epoxy resins. Epoxy resins derived from natural sources including, but not limited to, sugars, lignin, fatty acids, rosins, or combinations thereof may be utilized.

Non-aromatic epoxy resins may include non-aromatic hydrogenated cyclohexane dimethanol and diglycidyl ethers of hydrogenated bisphenol A-type epoxy resin, such as hydrogenated bisphenol A-epichlorohydrin epoxy resin, cyclohexane dimethanol diglycidylether, 3,4-epoxycyclohexylmethyl-3′,4′-epoxycyclohexane carboxylate and cycloaliphatic epoxy resin, or combinations thereof. Aromatic epoxy resins may include those resins produced from an epihalohydrin and a phenol or a phenol-type compound. The phenol-type compound includes compounds having an average of more than one aromatic hydroxyl group per molecule. Non-limiting examples of phenol-type compounds may include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

In at least one embodiment, which may be combined with other embodiments, the epoxy resin may be derived from a first compound comprising bisphenol A, bisphenol F, tetraglycidyl-methylenedianiline, terephthalic acid, phthalic acid, hexahydrophthalic acid, halogenated bisphenol, novolac, ortho-aminophenol, para-aminophenol, flourenone bisphenol, dicyclopentadiene, guaiacol, a guaiacol derivative, or combinations thereof. Guaiacol derivatives may include, for example, 4-methyl guaiacol, 4-ethyl guaiacol, eugenol, syringol, vanillin, or combinations thereof.

Ester functional groups present in the cured thermosetting resin matrix may facilitate degradation. Such ester functional groups may come from the thermosetting resin precursor (epoxy resin, polyester resin, or combinations thereof) to the cured thermosetting resin matrix. In at least one embodiment, which may be combined with other embodiments, the epoxy resin may comprise ester functional groups. Any suitable epoxy resin comprising ester functional groups may be utilized. Such epoxy resins comprising ester functional groups may be derived from a glycidyl fatty acid ester, diglycidyl ester, a triglycidyl ester, diglycidyl isophthalate, hexahydrophthalic acid diglycidyl ester, hexahydrophthalic anhydride glycidyl ester, 3,4-epoxycyclohexylmethyl-3′,4′-epoxycyclohexane carboxylate, glycidyl acrylate, glycidyl methacrylate, or combinations thereof.

The polyester resin may be any suitable polyester resin. The polyester resin may be derived from a second compound comprising an unsaturated ester, a vinyl ester, or combinations thereof. The polyester resin may have repeating units derived from diacids, glycols, or combinations thereof. Diacids from which polyester resin may be derived from may include, for example, phthalic acid, isophthalic acid, maleic anhydride, or combinations thereof. Glycols from which polyester resin may be derived from may include, for example, propylene glycol, ethylene glycol, or combinations thereof. Curing agents utilized to form polyester resins may include peroxides such as methyl ethyl ketone peroxide. Optionally, reactive diluents such as styrene may be used. Here, the styrene may act as a monomer that polymerizes with the polymer backbone during curing.

Illustrative, but non-limiting, examples of thermosetting resins used to form a cured thermosetting resin matrix of the composite material may include EPIKOTE™ Resin 760 (a hexahydrophthalic diglycidyl ester), EPIKOTE™ Resin 827 (a difunctional bisphenol A/diglycidyl ether liquid epoxy resin), EPIKOTE™ Resin MGS RIMR 035c (a commercially available blend of liquid epoxy resins and reactive diluents, constituting the resin part of a two component epoxy resin system used for the production of wind turbine blades via a vacuum-assisted resin infusion molding process), or combinations thereof. These thermosetting resins are available from Westlake Chemical Co.

Besides the thermosetting resin, the cured thermosetting resin matrix may be derived from a curing agent. The curing agent may be any suitable curing agent that cures the resin to form the cured thermosetting resin matrix. Curing agents are also referred to as hardeners. Curing agents may include anhydrides such as, for example, tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DBA), or combinations thereof. Curing agents may include amine-type curing agents, such as a polyamine (which may be aliphatic, cycloaliphatic, aromatic, or combinations thereof), a polyamide, a Mannich base, a polyaminoimidazoline, a polyetheramine, or combinations thereof. Examples include, but are not limited to, Jeffamine curing agents (available from Huntsman), Mannich bases such as those sold under the tradename EPIKURE™ Curing Agents (Westlake Chemical Co.) such as EPIKURE™ Curing Agent 110 or modified acid anhydrides sold under the tradename EPIKURE™ Curing Agents such as EPIKURE™ Curing Agent 05556. Curing agents may include cationic photoinitiators that absorb UV light to initiate polymerization. Such curing agents utilize a cationic photopolymerization mechanism. Cationic photoinitiators may include sulfonium salts, iodonium salts, or combinations thereof. Non-limiting examples of cationic photoinitiators may include triarylsulfonium hexafluoroantimonate salt, bis(4-tert-butylphenyl) iodinium perfluoro-1-butanesulfonate, or combinations thereof.

The curing agent may be derived from a third compound comprising an acrylate, a methacrylate, an anhydride, a carboxylic acid, an ester, an amine, a vinyl group, a Lewis acid, or combinations thereof. Combinations of curing agents are contemplated.

As described above, ester functional groups present in the cured thermosetting resin matrix may facilitate degradation. Such ester functional groups may come from the curing agent precursor to the cured thermosetting resin matrix such as a curing agent comprising one or more ester functional groups, a curing agent comprising one or more carboxylic acid functional groups. Such curing agents comprising an ester or carboxylic acid functional group may be derived from an acrylate, a methacrylate, hexahydrophthalic anhydride, methyl hexahydrophthalic anhydride, methyl tetrahydrophthalic anhydride, tetrahydrophthalic anhydride, isophthalate, fatty acid, or combinations thereof. Non-limiting examples of curing agents comprising an ester functional group may include, but are not limited to, reaction products of an amine with an acrylate, such as a reaction product of an amine with trimethylolpropane triacrylate (TMPTA), isooctyl acrylate, isobornyl acrylate, isoamyl acrylate, 2-ethyl hexyl acrylate, lauryl acrylate, or combinations thereof. Anhydrides and anhydride curing agents such as methyl tetrahydrophthalic anhydride (MTHPA) may be utilized.

Additionally, or alternatively, suitable curing agents may include, but are not limited to, an imidazole, a substituted imidazole, an imidazole adduct, an imidazole complex (for example, Ni-imidazole complex), a tertiary amine, a quaternary ammonium compound, a quaternary phosphonium compound, a dicyandiamide, a salicylic acid, urea, a urea derivative, a boron trifluoride complex, a boron trichloride complex (for example, boron trichloride alkylamine complex, an epoxy addition reaction product, a tetraphenylene-boron complex, an amine borate, a metal halide, an amine titanate, a metal acetylacetonate, a naphthenic acid metal salt, an octanoic acid metal salt, other metal salts, metal chelates, or combinations thereof. Curing agents may include, for example, boron trichloride dimethyloctylamine complex, oligomeric polyethylenepiperazines, bis-(dimethylaminopropyl)-amino-2-propanol, N,N′-bis-(3-dimethylaminopropyl) urea, N-(2-hydroxypropyl) imidazole, dimethyl-2-(2-aminocthoxy) ethanol, bis(2-dimethylaminoethyl) ether, pentamethyldiethylenetriamine, dimorpholinodiethyl ether, 1,8-diazobicyclo[5.4.0]undec-7-ene (DBU), 1-methylimidazole, 1,2-dimethylimidazole, methyl nadic anhydride, triethylenediamine, 1,1,3,3-tetra-methylguanidine, tin (IV) chloride, tin octoate, or combinations thereof.

Curing agents may include cationic photoinitiators containing sulfonium or iodonium salts such as triarlysulfonium hexafluoroantimonate, bis(4-tertbutylphenyl) iodonium perfluoro-1-butanesulfonate, or combinations thereof.

Illustrative, but non-limiting, examples of curing agents used to form a cured thermosetting resin matrix of the composite material may include EPIKURE™ Curing Agent RIMH 037 (an amine curing agent, specifically a commercially available blend of aliphatic and polyetheramines, constituting the curing agent part of a two component epoxy resin system used for the production of wind turbine blades via a VARIM process, and EPIKURE™ Curing Agent CCA 139 (an anhydride curing agent, specifically methyl tetrahydrophthalic anhydride (MTHPA)). EPIKURE™ Curing Agent RIMH 037 and EPIKURE™ Curing Agent CCA 139 are commercially available from Westlake Chemical Co.

The optional reactive diluent(s) utilized to form the cured thermosetting resin matrix may include butanediol, hexanediol, pentaerythritol, glycerin, TMPTA, a fatty alcohol (such as tall oil fatty acid, lauryl acid, myristic acid, or combinations thereof), a fatty acid (such as lauryl alcohol, myristyl alcohol, decanol, cetyl alcohol, or combinations thereof), or combinations thereof. Other optional reactive diluents are contemplated. Reactive diluents comprising an ester group may include TMPTA, isooctyl acrylate, isobornyl acrylate, isoamyl acrylate, 2-ethyl hexyl acrylate, lauryl acrylate, or combinations thereof.

The inventors also discovered that ester groups present in the cured thermosetting resin matrix may facilitate degradation or decomposition of the cured thermosetting resin matrix. In some embodiments, which may be combined with other embodiments, the cured thermosetting resin matrix may be derived from an ester-containing compound. The cured thermosetting resin matrix may be derived from an epoxy resin containing comprising one or more ester functional groups, a polyester resin, a reactive diluent comprising one or more ester functional groups, a curing agent comprising one or more ester functional groups, a curing agent comprising a carboxylic acid functional group, or combinations thereof. Prior to curing, a ratio of ester functional groups to epoxy groups present in the thermosetting resin may be from about 0.05:1 to about 9.5:1, such as from about 0.05:1 to about 5.5:1, such as about 0.1:1 to about 2:1.

Referring back to operation 110, through contact of the cured thermosetting resin matrix with the amine, the polymer skeleton of the cured thermosetting resin matrix degrades or decomposes by chain scission. “Chain scission” refers to breaking of covalent bonds that make up the molecular structure of the cured thermosetting resin matrix. Chain scission causes the cured thermosetting resin matrix to degrade into smaller residues. The degraded residues may be amine-rich as a result of the reaction of the cured thermosetting resin matrix with the amine, though non-amine-containing residues may also be formed. The degraded residues may include reaction products from reaction of the amine with C—N bonds, C—O bonds, ester bonds, or combinations thereof, among others, present in the cured thermosetting resin matrix. The degraded residues may be in the form of monomers, oligomers, or combinations thereof. One of ordinary skill in the art would understand that, depending on the amine and the cured thermosetting resin matrix, the degraded residues and amounts thereof may be different.

For example, the cured thermosetting resin matrix may include beta-amino alcohol functional groups (having both C—N bonds and C—O bonds), such as those cured resins derived from epoxy resins and an amine curing agent, which are reactive with amines. Degraded residues comprising amine reaction products may be formed by operation 110 via reaction of the amine with C—O bond, a C—N bond, or both, of the cured thermosetting resin matrix.

As another example, the cured thermosetting resin matrix may include ester functional groups, such as those cured thermosetting resin matrices derived from polyesters, epoxy resins containing ester functional groups, or curing agents containing ester groups, which are reactive with amines. Degraded residues comprising amide reaction products may be formed by operation 110 via reaction of the amine with one or more ester groups present in the cured thermosetting resin matrix. These amide-containing residues may be formed by a substitution reaction that facilitates degradation of the cured thermosetting resin matrix.

The degraded residues from the reaction between the amine and the cured thermosetting resin matrix may have a molecular structure that allows the residues to become solubilized in the resulting reaction product mixture. Additionally, or alternatively, the degraded residues from the reaction between the amine and the cured thermosetting resin matrix may have a molecular weight that is low enough to become solubilized in the resulting reaction product mixture.

Operation 110 may be performed under any suitable reaction conditions, such as weight ratios of materials, reaction temperatures, reaction times, or reaction pressures, among other reaction conditions, to form the reaction product mixture. Reaction conditions may include a weight ratio of amine to composite material in the reaction mixture of operation 110. The weight ratio of the amine to the composite material in the reaction mixture may be from about 1:1 to about 20:1, such as from about 2:1 to about 15:1, such as from about 3:1 to about 12:1, such as from about 5:1 to about 10:1.

At operation 110, the reaction mixture may be reacted at any suitable reaction temperatures. Suitable reaction temperatures may be about 250° C. or less, such as about 200° C. or less, such as about 170° C. or less, such as about 150° C. or less. Additionally, or alternatively, the reaction mixture may be reacted at a temperature that is from about 20° C. to about 250° C., such as from about 50° C. to about 200° C., such as from about 50° C. to about 200° C., such as from about 80° C. to about 170° C., such as from about 100° C. to about 150° C., such as from about 110° C. to about 130° C. Additionally or alternatively, the reaction mixture may be reacted at a temperature that is the glass transition temperature (Tg) of the cured thermosetting resin matrix or at a temperature that is higher than the Tg of the cured thermosetting resin matrix. Reaction temperature is the temperature monitored by a temperature probe.

Operation 110 may be performed for any suitable reaction time. The reaction time may be about 100 hours or less, such as about 50 hours or less, such as about 24 hours or less, such as from about 0.5 h to about 15 hours, such as from about 1 h to about 13 hours, such as from about 2 hours to about 12 hours, such as from about 4 hours to about 10 hours, such as from about 5 hours to about 9 hours. The reaction time may be based on the temperature at which the reaction mixture is reacted.

The reaction of operation 110 may be performed at any suitable reaction pressure. The reaction pressure may be about 5 atm (about 510 kPa) or less, such as from about 0.8 atm (about 81 kPa) to about 1.2 atm (about 121 kPa), such as from about 0.9 atm (about 91 kPa) to about 1.1 atm (about 111 kPa), such as about 1 atm (about 101 kPa).

The reaction mixture of operation 110 may be stirred, mixed, agitated, circulated, sonicated, ultrasonicated, or combinations thereof. The apparatus used to perform stirring, mixing or agitation may include a batch reaction vessel, a semi-batch reaction vessel, a continuous static mixer, or other suitable apparatus. Mechanical agitation or jet mixing may be used. Stirring, mixing, agitating, circulating, sonication, ultrasonication, or combinations thereof of the reaction mixture, or components thereof, supports both diffusion of the amine through the cured thermosetting resin matrix and separating the degraded residues out of the cured thermosetting resin matrix.

The reaction conditions of operation 110 may optionally include utilizing a non-reactive gas, such as nitrogen, argon, or combinations thereof. For example, the reaction mixture comprising the amine and composite material may be used with these or other non-reactive gases to degas various components or otherwise remove oxygen from the reaction mixture.

The reaction product mixture produced during operation 110 may be a suspension or slurry containing solid reinforcement materials and an organic liquid composition. The process 100 may further include isolating the reinforcement material from the reaction production mixture at operation 120 and isolating an organic liquid composition from the reaction production mixture at operation 130. Operations for isolating the reinforcement material (for example, operation 120) and for isolating the organic liquid composition (for example, operation 130) may be performed at the same time. That is, the isolating the reinforcement material from the reaction product mixture and the isolating the organic liquid composition from the reaction product mixture may be performed concurrently or sequentially.

The reinforcement material (solids) and the organic liquid composition (liquid) may be isolated from the reaction product mixture using any suitable separation technique, such as solid-liquid separation techniques including mechanical separation or gravity separation, such as filtration, vacuum filtration, centrifugation, decanting, decanting centrifugation, combinations thereof, among other techniques. Separation may be aided by placing the reaction product mixture at a temperature that is from about 20° C. to about 40° C. Separation may be aided by pressing of the solid filter cake that forms. Filtration may be accomplished using a porous surface to draw the filtrate (organic liquid composition) from the reaction product mixture to one side of the porous surface, and leaving the retentate (solid reinforcement material) on the opposite side of the porous surface. The organic liquid composition may be directly recovered or partly distilled in, for example, the case of using a large excess of amine. The isolation process of operation 120 and the isolation process of 130 may be performed one or more times.

The isolated reinforcement material may be recycled into new applications, as described below.

The isolated organic liquid composition includes residues, such as degraded polymers, produced from the reaction of the amine with the cured thermosetting resin matrix. The organic liquid may also include unreacted amine. Other components may be present in the organic liquid composition. Depending on the cured thermosetting resin matrix and conditions used for the reacting in operation 110, the organic liquid composition may include amines, amides, alcohols, oligomers (such as amino-functionalized oligomers or hydroxy-functionalized oligomers), or combinations thereof. The isolated organic liquid composition may be recycled into new applications, described below. For example, the degraded residues may be used as building blocks for forming resins, curing agents, and composite materials, among other applications.

For operations 120 and 130, whether performed separately or together, the reaction product mixture may be allowed to cool, or be cooled to, about 15° C. to about 25° C. and then the reinforcement material and the organic liquid composition may be isolated. Alternatively, operation 120, operation 130, or both, may be performed at elevated temperatures.

The isolated reinforcement materials and the isolated organic liquid composition may be utilized for new applications as described below.

FIG. 2 is a flowchart showing selected operations of a process 200 for recycling a composite material comprising a cured thermosetting resin matrix and a reinforcement material. Process 200 is an alternative embodiment to process 100. As shown, processes for recycling a composite material described herein may include a pretreatment at operation 205. Additionally, or alternatively, processes for recycling a composite material described herein may include an optional post-treatment at optional operation 235. Operations 210, 220, and 230 of process 200 may be the same as, or similar to, operations 110, 120, and 130, respectively, of process 100. Embodiments and implementations of process 200 may be combined with other embodiments described herein.

Prior to the reacting the composite material with the amine at operation 210, the process 200 may include pretreating the composite material at operation 205. Pretreating the composite material may include chemical treatment, mechanical treatment, or combinations thereof. For example, pretreating the composite material may include comminuting the composite material, mixing the composite material with a swelling agent, or combinations thereof.

The composite material may be comminuted with a shredder, a hammer mill, a grinder, a granulator, or combinations thereof. Comminution allows the composite materials to broken into pieces of various sizes. For example, following comminution, the composite material may be in the form of a powder, or it may be present in dimensions of up to 50 cm or more.

Swelling agents may be used to cause components of the composite material to expand, which may aid the degradation of the cured thermosetting resin matrix. Suitable swelling agents may include the following: water, acids such acetic acid, or combinations thereof; alcohols such as methanol, ethanol, isopropanol, or combinations thereof; glycols such as ethylene glycol; tertiary amines such as 2,4,6-trisdimethyl aminophenol and dimethyldodecyl amine; an ester such as propylene carbonate; an ether such as propylene glycol methyl ether; a lactam such as caprolactam; a lactone such as gamma-valerolactone; or combinations thereof. Combinations of swelling agents in any suitable proportions, may be utilized.

When the pretreatment includes mixing the composite material with a swelling agent, the composite material may be mixed with the swelling agent under suitable conditions including a temperature that is from about 50° C. to about 120° C. for a period of about 1 hour to about 24 hours, such as a temperature that is from about 80° C. to about 100° C. for a period of about 2 hours to about 6 hours.

After the pretreatment, process 200 includes reacting a reaction mixture comprising an amine and the pretreated composite material to form the reaction product mixture at operation 210. Operation 210 may be the same as, or similar to, operation 110 of process 100. The reinforcement material may be isolated at operation 220 and the organic liquid composition comprising the degraded residues may be isolated at operation 230. Operation 220 and operation 230 may be the same as, or similar to, operation 120 and operation 130 of process 100.

Embodiments described herein advantageously enable use of the degraded residues from the cured thermosetting polymer matrix. Following operation 230, the organic liquid composition and the reinforcement material may be upgraded by further downstream processing. Accordingly, the process 200 may further include optionally performing post-treatment processing of the organic liquid composition, the reinforcement material, or combinations thereof, at optional operation 235.

As described herein, the organic liquid composition includes degraded residues (products) from the reaction of the amine with the cured thermosetting resin matrix, such as amines, amides, alcohols, oligomers, or combinations thereof. The organic liquid composition may also include unreacted amine. These degraded residues and unreacted amine may be used as building blocks for new materials. As a result, the organic liquid composition may be used in a variety of ways.

For example, the organic liquid composition itself may be recycled into new applications. As an example, the optional post-treatment of the organic liquid composition at optional operation 235 may include introducing an epoxy resin to the organic liquid composition and reacting the epoxy resin with the degraded residues under conditions effective to form adducts from the epoxy resin and the degraded residues. In addition, unreacted amine may be present in the organic liquid composition. The unreacted amine may be utilized as a building block in, for example, epoxy resins and polyurethane resins. That is, the amine may be used to form adducts with the epoxy resin under conditions effective to form adducts from the epoxy resin and the unreacted amine.

Additionally, or alternatively, the optional post-treatment of the organic liquid composition at optional operation 235 may include performing a liquid-liquid separation on the organic liquid composition. Any suitable liquid-liquid separation technique may be used including, but not limited to, distillation, fractionations, extraction, decantation, and coalescence.

Additionally, or alternatively, the optional post-treatment of the organic liquid composition at optional operation 235 may include introducing a curing agent to the organic liquid composition to form a second cured thermosetting resin matrix that is different from the thermosetting resin matrix of the composite material put into process 200. Here, degraded residues present in the organic liquid composition may react with the curing agent and form the second cured thermosetting resin matrix. The second cured thermosetting resin matrix may be mixed with a reinforcement material to form a new composite material.

Additionally, or alternatively, the optional post-treatment of the organic liquid composition at optional operation 235 may include introducing a curing agent to the organic liquid composition to form a curable thermosetting resin matrix. Here, the degraded residues may be blended with curing agent to form the curable thermosetting resin matrix. The curable thermosetting resin matrix may be used for various applications. For example, the curable thermosetting resin matrix may be mixed with a reinforcement material to form a new composite material.

Additionally, or alternatively, the optional post-treatment of the organic liquid composition at optional operation 235 may include introducing a curing agent and an epoxy resin to the organic liquid composition to form a curable thermosetting resin matrix. Here, the degraded residues may be blended with the curing agent and the epoxy resin to form the curable thermosetting resin matrix. The curable thermosetting resin matrix may be used for various applications. For example, the curable thermosetting resin matrix may be mixed with a reinforcement material to form a new composite material.

Additionally, or alternatively, the optional post-treatment of the organic liquid composition at optional operation 235 may include recycling the organic liquid composition to operation 210. Here, the organic liquid composition may include unreacted amine, which may be used in operation 210. The organic liquid composition may be recycled directly to operation 210 or unreacted amine may be isolated from the organic liquid composition and then the unreacted amine used for operation 210.

Additionally, or alternatively, the optional post-treatment of the organic liquid composition at optional operation 235 may include recycling the organic liquid composition to operation 220, operation 230, or combinations thereof, to aid in the isolation of reinforcement material, to aid in the isolation of an organic liquid composition, or combinations thereof.

In some embodiments, which may be combined with other embodiments, the process 200 may be free of a separation operation between the isolating the organic liquid composition from the reaction product mixture (for example, operation 230) and the performing the post-treatment processing of the organic liquid composition (for example, optional operation 235). That is, the process 200 may be free of a separation operation between operation 230 and optional operation 235, and the organic liquid composition may be used directly for suitable applications such as those described herein.

Additionally, or alternatively, the optional post-treatment of the organic liquid composition at optional operation 235 may include isolating different degraded residues, associated with different molecular weights, by performing a distillation, solvent extraction, or combinations thereof on the organic liquid composition.

The inventors also found that the cured thermosetting resin matrix comprising ester functional groups is thermally-reformable. Here, the degraded residues may be cured and molded at desired temperatures and pressures to form a compressing mold. The thermo-reformability may be due to transesterification reactions.

The ester functional groups provide at least two benefits: (1) the ester functional groups of the cured thermosetting resin matrix comprising facilitate reaction with the amine to form degraded residues; and (2) the obtained degraded residues—which contain amide groups—may be utilized as a curing agent with an epoxy resin to obtain a thermally-reformable cured system.

The reinforcement material isolated by processes described herein may also be subjected to post-treatment processing. The optional post-treatment of the reinforcement material at optional operation 235 may include washing, optionally treating the reinforcement material isolated from the reaction product mixture utilizing suitable techniques. The optional treating of the reinforcement material may include drying the washed reinforcement material, adding a sizing agent to the washed reinforcement material, or combinations thereof. Sizing agents may be added to the reinforcement material to coat the surface of the reinforcement material, protecting them from breakage, making them more compatible with resin matrix systems, promoting adhesion between reinforcement materials and resin matrix systems, providing chemical resistance to reinforcement materials, or to provide thermal stability to reinforcement materials.

Additionally, or alternatively, the optional post-treatment of the reinforcement material at optional operation 235 may include processing the washed, and optionally treated, reinforcement material into a yarn, a woven fabric, a non-woven fabric, pellets, milled pellets, fibers, a second composite material, or combinations thereof.

Another optional operation (not shown) for process 200 may include utilization of at least a portion of the reaction product mixture. Here, after the reacting process of operation 210 and before the isolating process of operation 220, at least a portion of the reaction product mixture (a slurry) may be taken and, without separation, used in a variety of applications such as adhesives, insulation materials, coatings, thermoset composites, insulation materials, bulk molding compounds (BMCs), and sheet molding compounds (SMCs). BMCs and SMCs may be utilized for composite applications such as for the automotive, appliance, electrical, or construction industries. This optional operation that includes removing at least a portion of the reaction product mixture and using the reaction product mixture directly, without separation, may also be performed with process 100.

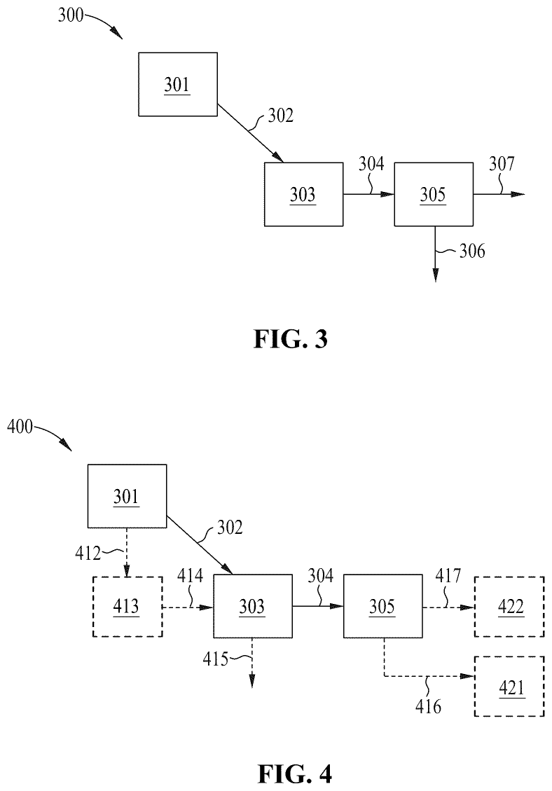

FIGS. 3 and 4 are generalized schematic flow diagram illustrating various embodiments of processes described herein corresponding to operational areas or units in composite material processing plant 300 and composite material processing plant 400, respectively. Plant 300 relates to process 100 and plant 400 relates to process 200 and to portions of process 100. However, plants 300 and 400 are utilized for illustrative purposes only and are not intended to limit the scope of processes described herein such as processes 100 and 200. Embodiments and implementations of plant 300 and plant 400 may be combined with other embodiments described herein.

Plant 300 includes a feedstock unit 301 holding the composite material to-be-processed. The composite material to-be-processed may exit the feedstock unit 301 and travel through line 302 to a reactor unit 303. At the reactor unit 303, operation 110 may be performed, whereby a reaction mixture that includes a composite material and an amine arc reacted to form a reaction product mixture. The reaction product mixture, which may be a slurry, may exit the reactor unit 303 and travel through line 304 to a solid-liquid separation unit 305. At the solid-liquid separation unit 305, operation 120 may be performed, whereby the reinforcement material may be isolated from the reaction product mixture. In addition, operation 130 may be performed at the solid-liquid separation unit 305, whereby the organic liquid composition, an organic recyclate, may be isolated from the reaction product mixture. As described herein, these operations may be performed concurrently or sequentially. The isolated organic liquid composition may exit the solid-liquid separation unit 305 through line 306. The isolated reinforcement material may exit solid-liquid separation unit 305 through line 307.

FIG. 4 is a generalized schematic flow diagram illustrating various embodiments of processes described herein corresponding to operational areas or units in plant 400. In addition to those elements described in FIG. 3, plant 400 includes upstream and downstream units, indicated in dashed lines, for pretreatment and post-treatment operations, respectively. Although upstream and downstream units are shown, the upstream or downstream units may be avoided. For example, processes for recycling a composite material may include the pretreatment, the optional post-treatment, or combinations thereof.

Plant 400 includes a feedstock unit 301 holding the composite material to-be-processed. The composite material to-be-processed may exit the feedstock unit 301 and travel through line 412 to a pretreatment unit 413. At the pretreatment unit 413, operation 205 may be performed, whereby the composite material may be pretreated by, for example, comminution of the composite material, swelling of the composite material, or combinations thereof. The pretreated composite material may exit the pretreatment unit 413 via line 414 and travel to reactor unit 303. At the reactor unit 303, operation 210 may be performed, whereby a reaction mixture that includes a composite material and an amine are reacted to form a reaction product mixture. The reaction product mixture, which may be a slurry, may exit the reactor unit 303 and travel through line 304 to solid-liquid separation unit 305. At the solid-liquid separation unit 305, operation 220 may be performed, whereby the reinforcement material may be isolated from the reaction product mixture. In addition, operation 230 may be performed at the solid-liquid separation unit 305, whereby the organic liquid composition, an organic recyclate, may be isolated from the reaction product mixture. The organic liquid composition may exit the solid-liquid separation unit 305 through line 416. The isolated reinforcement material may exit solid-liquid separation unit 305 through line 417.

The isolated organic liquid composition, containing degraded residues, may travel to optional organic liquid composition post-treatment unit 421 via line 416. At the optional organic liquid composition post-treatment unit 421, optional operation 235 may be performed, whereby components (for example, degraded residues, unreacted amine, or combinations thereof) may be reacted with an epoxy resin to form new adducts. Other post-treatment operations for the isolated organic liquid composition are described herein.

The isolated reinforcement material may travel to optional reinforcement material post-treatment unit 422 via line 417. At the optional reinforcement material post-treatment unit 422, optional operation 235 may be performed whereby, the isolated reinforcement material may be washed, dried, or both. Other post-treatment operations for the isolated reinforcement material are described herein.

Plant 400 also includes optional line 415, whereby at least a portion of the reaction product mixture (a slurry) may be taken from reactor unit 303 and be used directly in a variety of applications and uses such as adhesives, insulation materials, coatings, thermoset composites, insulation materials, BMCs, SMCs, or combinations thereof, among other applications and uses.

Embodiments of the present disclosure generally relate to processes for recycling a composite material. The components of the composite material—the reinforcement material and the cured thermosetting resin matrix (or degraded residues thereof)—may be isolated and used for further processing. Advantageously, embodiments of processes described herein may be performed without the use of solvent. Because no solvent is involved, energy-intensive solvent recovery methods are not needed. In addition, embodiments described herein provide the option of using the isolated organic liquid composition without removing unreacted amine. Here, unreacted amine may be utilized as a building block in, for example, epoxy resins and polyurethane resins. The degraded residues of the cured thermosetting resin matrix may also participate in downstream reactions to form new materials. Further, the isolated organic liquid composition (an organic recyclate) may be cured and thermoformed in contrast to conventional technologies that do not enable thermoforming of recycled materials.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Examples of processes described herein were performed using various materials set out in the Materials and are described below.

### Materials

Non-limiting reinforcement materials included glass fibers and carbon fibers. Non-limiting amines used for example processes included 2-methylpentane-1,5-diamine (MPDA) and isophorone diamine (IPDA). Non-limiting thermosetting resins used to form cured thermosetting resin matrices included EPIKOTE™ Resin MGS RIMR 035c (a commercially available blend of liquid epoxy resins and reactive diluents, constituting the resin part of a two component epoxy resin system used for the production of wind turbine blades via a vacuum-assisted resin infusion molding (VARIM) process), EPIKOTE™ Resin 760 (a hexahydrophthalic diglycidyl ester), EPIKOTE™ Resin 827 (a difunctional bisphenol A/diglycidyl ether liquid epoxy resin). EPIKOTE™ Resin 760 includes ester functional groups. Non-limiting curing agents to form cured thermosetting resin matrices included EPIKURE™ Curing Agent RIMH 037 (an amine curing agent, specifically a commercially available blend of aliphatic and polyetheramines, constituting the curing agent part of a two component epoxy resin system used for the production of wind turbine blades via a VARIM process, EPIKURE™ Curing Agent CCA 139 (an anhydride curing agent, specifically MTHPA), and TMPTA. TMPTA curing agent includes ester functional groups and MTHPA includes an anhydride functional group.

### EXAMPLE PROCESSES

### Example 1

A glass-fiber reinforced composite material was made using 70 wt % glass fiber reinforcement material, with EPIKOTE™ Resin MGS RIMR 035c and EPKIURE Curing Agent MGS RIMH 037 forming the cured thermosetting resin matrix.

To the composite material was added MPDA, IPDA, or both. The resultant reaction mixture was heated at 80° C. or at 120° C. to form the reaction product mixture. The organic liquid composition and the reinforcement materials were isolated from the reaction product mixture by filtering the reaction product mixture over a 200 μm filter at a temperature that is from 20° C. to 40° C. The filtrate (organic liquid composition) was collected and set aside. The retentate (reinforcement material) was washed with 35 mL ethanol (3×35 mL). After each wash, the reinforcement material and ethanol was separated with the aid of a 200 μm filter. The reinforcement material was then dried for a period of 2 hours to 3 hours at a temperature that is from 80° C. to 100° C. Parameters for the reaction and results are shown in Table 1-1.

TABLE 1

| Example | Ex. 1-1 | Ex. 1-2 | Ex.1-3 |
|---|---|---|---|
| Composite material | 1 | 1 | 1 |
| Weight ratio of | 10:1 | 10:1 | 10:1 |
| amine to composite | | | |
| material | | | |
| Amine | MPDA | 1:1 MPDA/ | 1:10 MPDA/ |
| | | IPDA | IPDA |
| Reaction | 80 | 120 | 120 |
| temperature, ° C. | | | |
| Reaction time, h | 7 | 2 | 4 |
| Result | All fibers | All fibers | All fibers |
| | separated | separated | separated |
| | from degraded | from degraded | from degraded |
| | matrix | matrix | matrix |

Overall, the results from Table 1-1 indicate that processes described herein may be utilized to recycle composite materials. For example, and as shown in Table 1, Ex. 1-1 indicated that glass fibers are fully separated from cured thermosetting resin matrix using MPDA at 80° C. for 7 h. Following washing, clean glass fibers were obtained.

Ex. 1-2 and Ex. 1-3 used different ratios of MPDA to IPDA at a reaction temperature of 120° C. Here, the results indicated that when more IPDA is utilized, the time for degradation increases. While not wishing to be bound by any theory, this may be a result of the higher steric hindrance and lower reactivity of IPDA (having a cyclic structure) relative to MPDA (having a linear structure). Relative to cycloaliphatic diamines such as IPDA, the linear alkyl diamine MPDA has higher mobility and more easily diffuses into the composite material. With its lower overall steric hindrance, MPDA may be more capable of interacting and reacting with functional groups present in the cured thermosetting resin matrix.

It is noted that the glass fiber reinforced material for this example is useful for wind-turbine blade manufacturing. Therefore processes described herein may be used to recycle composite materials used in, at least, renewable energy industries.

### Example 2

Investigations into the dissolution of the cured thermosetting resin matrix alone were also performed. Here, no reinforcement material was used. Only the cured thermosetting resin matrix—formed from EPIKOTE™ Resin MGS RIMR 035c and EPIKURE™ Curing Agent MGS RIMH 037—was reacted with amine. Results are shown in Table 2.

TABLE 2

| Example | Ex. 2-1 | Ex. 2-2 | Ex.2-3 |
|---|---|---|---|
| Amine | MPDA | MPDA | MPDA |
| Weight ratio of | 10 | 10 | 10 |
| amine to cured | | | |
| thermosetting | | | |
| resin matrix | | | |
| Reaction | 80 | 80 | 120 |
| temperature, ° C. | | | |
| Reaction time, h | 7 | 14 | 7 |
| Observation | Swollen; partial | Swollen; partial | Swollen; partial |
| | degradation, | degradation | degradation |
| | particles visible | particles visible | particles visible |

As shown in Table 2, a swelling of the thermosetting resin matrix, with partial dissolution, was observed when the reaction (degradation) is performed for 7 hours or 14 hours. This may be explained by the surface erosion mode of degradation which is diffusion controlled. For example, in a glass fiber reinforcement material that includes both a reinforcement material and a cured thermosetting resin matrix, the fiber-matrix interface contributes to the overall surface area. As a result, degradation may occur at a higher rate with the larger overall surface area, and thus, a composite material containing both reinforcement material and cured thermosetting resin matrix may be more easily degraded than a cured thermosetting resin matrix alone.

### Example 3

Cured thermosetting resin matrices that include ester functional groups were also investigated for degradation by reaction with MPDA at different temperatures. The cured thermosetting resin matrices were formed from the formulation shown in Table 3. EPIKOTE™ Resin 760 is an epoxy resin comprising ester functional groups, EPIKOTE™ Resin 827 is an epoxy resin, TMPTA is a curing agent comprising ester functional groups, and EPIKURE™ Curing Agent MGS RIMH 037 is an amine curing agent.

TABLE 3

| | | | | | |
|---|---|---|---|---|---|
| Example | Ex. 3-1 | Ex. 3-2 | Ex. 3-3 | Ex. 3-4 | Ex. 3-5 |

Cured thermosetting resin matrix

| | | | | | |
|---|---|---|---|---|---|
| EPIKOTE ™ Resin 760 | 30 | 40 | 20 | 100 | 100 |
| EPIKOTE ™ Resin 827 | 60 | 50 | 70 | 0 | 0 |
| TMPTA | 10 | 10 | 10 | 0 | 0 |
| EPIKURE ™ Curing | 26.5 | 26.6 | 26.4 | 30.4 | 30.4 |
| Agent MGS RIMH037 | | | | | |
| Total resin + | 100 | 100 | 100 | 100 | 100 |
| curing agent | | | | | |

Reaction parameters

| | | | | | |
|---|---|---|---|---|---|
| Amine | MPDA | MPDA | MPDA | MPDA | MPDA |
| Weight ratio of | 20:1 | 20:1 | 20:1 | 20:1 | 20:1 |
| amine to cured | | | | | |
| thermosetting | | | | | |
| resin matrix | | | | | |
| Reaction | 23 | 23 | 23 | 23 | 80 |
| temperature, ° C. | | | | | |
| Reaction time | 1 month | 1 month | 1 month | 1 month | 7 h |

Overall, the results shown in Table 3 indicate that cured thermosetting resin matrices comprising ester functional groups may be degraded using embodiments described herein. For example, Ex. 3-5 indicates that a cured thermosetting resin matrix derived from EPIKOTE™ Resin 760 resin (a hexahydrophthalic diglycidyl ester) and EPIKURE™ Curing Agent MGS RIMH 037 was completely degraded after 7 h at 80° C. Ex. 3-4 shows that the same cured thermosetting resin matrix may be completely degraded at room temperature after 1 month.

Cured thermosetting resin matrices of Ex. 3-1, Ex. 3-2, and Ex. 3-3 were made from different proportions of EPIKOTE™ Resin 760 resin (a hexahydrophthalic diglycidyl ester) and EPIKOTE™ Resin 827 (a difunctional bisphenol A/diglycidyl ether liquid epoxy resin). Besides the EPIKURE™ Curing Agent MGS RIMH 037 curing agent, Ex. 3-1, Ex. 3-2, and Ex. 3-3 were made with an additional ester-containing curing agent TMPTA. These may also dissolve at room temperature.

Although not shown, when the cured thermosetting resin matrices of Ex. 3-1, Ex. 3-2, and Ex. 3-3 are reacted with amine at 80° C., the cured thermosetting resin matrices fully dissolves in 10 hours or less.

Relative to the results shown in Table 1 and Table 2, the results shown in Table 3 indicate that cured thermosetting resin matrices comprising ester functional groups may degrade more easily than cured thermosetting resin matrices without ester functional groups.

### Example 4

A carbon-fiber reinforced composite material was obtained from the spar cap of a decommissioned wind-turbine blade, originally produced with an anhydride cured epoxy resin system. The spar cap anhydride cured epoxy resin system included EPIKOTE™ Resin CS 531 (commercially available modified blend of liquid epoxy bisphenol A and F resins) with EPIKURE™ Curing Agent CCA 139. The composite material was degraded by reacting with MPDA at 80° C. for 6 hours. The cured thermosetting resin matrix completely dissolved. This result indicates that cured thermosetting resin matrices present in composite materials may be completely dissolved by using embodiments of the present disclosure.

### Example 5

Example 5 relates to thermo-reformability as additional benefit of the easier-to-degrade epoxy resins having ester functional groups. In this example, 50 wt % EPIKOTE™ Resin 760 epoxy resin (an epoxy resin comprising ester functional groups) and 50 wt % EPIKOTE™ Resin 827 epoxy resin were cured with EPIKURE™ Curing Agent MGS RIMH 037. After curing, the cured resin matrix was milled into fine particles. The particles were filled into a mold of a compression molding press. After 1 hour at 180° C. and a pressure of 20 bar (2,000 kPa), a mold was obtained. This example indicates that resin systems comprising ester functional groups are not only easier to degrade than resins without ester functional groups, but that the degraded residues are also thermally-reformable. The thermo-reformability may be due to transesterification reactions.

Embodiments described herein generally relate to processes for recycling a composite material. Advantageously, processes described herein may be performed without the use of solvent. Because no solvent is involved, energy-intensive solvent recovery methods are not needed. In addition, embodiments described herein provide the option of using the isolated organic liquid composition without removing the amine. Here, the amine may be utilized as a building block in, for example, epoxy resins and polyurethane resins.

Embodiments described herein generally relate to processes for recycling a composite material. The inventors show that the components of the composite material—the reinforcement material and the cured thermosetting resin matrix (or degraded residues thereof)—may be isolated and used for further processing. Embodiments described herein may be performed without the use of solvent, removing the costs and time associated with energy-intensive solvent recovery methods are not needed. In addition, the both the degraded residues and unreacted amine (if any) in the organic liquid composition may be utilized for downstream processing without separation.

### EMBODIMENTS OF THE DISCLOSURE

The present disclosure provides, among others, the following embodiments, each of which may be considered as optionally including any alternate embodiments:

Embodiment 1. A process for recycling a composite material, the process comprising:
reacting, at a reaction temperature of about 250° C. or less, a reaction mixture comprising:
   an amine; and
   a composite material comprising:
   a reinforcement material; and
   a cured thermosetting resin matrix to form a reaction product mixture, the amine comprising at least one primary or secondary amine group, the amine being reactive with the cured thermosetting resin matrix at the reaction temperature;
isolating the reinforcement material from the reaction product mixture; and
isolating an organic liquid composition from the reaction product mixture, the organic liquid composition comprising degraded residues produced from the reacting the amine and the cured thermosetting resin matrix.

Embodiment 2. The process of Embodiment 1, wherein:
the amine comprises two primary amines;
the amine is a fully saturated acyclic amine, a fully saturated cyclic amine, or combinations thereof; or
combinations thereof.

Embodiment 3. The process of any one of the preceding Embodiments, wherein a weight ratio of the amine to the composite material is from about 1:1 to about 20:1.

Embodiment 4. The process of any one of the preceding Embodiments, wherein the amine comprises 2-methylpentane-1,5-diamine, hexane diamine, 1,3-bis(aminomethyl)cyclohexane, triethylene tetramine, isophorone diamine, hexylamine, or combinations thereof.

Embodiment 5. The process of any one of the preceding Embodiments, wherein the cured thermosetting resin matrix is derived from:
a resin comprising an epoxy resin, a polyester resin, or combinations thereof;
a curing agent; and
an optional reactive diluent.

Embodiment 6. The process of Embodiment 5, wherein:
the epoxy resin is derived from a first compound comprising bisphenol A, bisphenol F, tetraglycidyl-methylenedianiline, terephthalic acid, phthalic acid, hexahydrophthalic acid, halogenated bisphenol, novolac, ortho-aminophenol, para-aminophenol, flourenone bisphenol, dicyclopentadiene, guaiacol, 4-methyl guaiacol, 4-ethyl guaiacol, eugenol, syringol, vanillin, or combinations thereof;
the polyester resin is derived from a second compound comprising an unsaturated ester, a vinyl ester, or combinations thereof;
the curing agent is derived from a third compound comprising an acrylate, a methacrylate, an anhydride, an ester, an amine, a Lewis acid, or combinations thereof;
the optional reactive diluent comprises butanediol, hexanediol, pentaerythritol, glycerin, trimethylolpropane triacrylate, a fatty alcohol, a fatty acid, or combinations thereof; or
combinations thereof.

Embodiment 7. The process of any one of the preceding Embodiments, wherein:
the degraded residues comprise amide reaction products from reaction of the amine with one or more ester groups present in the cured thermosetting resin matrix;
the degraded residues comprise amine reaction products from reaction of the amine with a C—O bond, a C—N bond, or combinations thereof, of the cured thermosetting resin matrix; or
combinations thereof.

Embodiment 8. The process of any one of the preceding Embodiments, wherein:
the cured thermosetting resin matrix comprises one or more ester functional groups; and
the cured thermosetting resin matrix comprising one or more ester functional groups is derived from an epoxy resin comprising an ester functional group, a curing agent comprising an ester functional group, a curing agent comprising a carboxylic acid functional group, or combinations thereof.

Embodiment 9. The process of Embodiment 8, wherein:
the epoxy resin comprising the ester functional group is derived from a glycidyl fatty acid ester, diglycidyl ester, a triglycidyl ester, diglycidyl isophthalate, hexahydrophthalic acid diglycidyl ester, hexahydrophthalic anhydride glycidyl ester, 3,4-epoxycyclohexylmethyl-3′,4′-epoxycyclohexane carboxylate, glycidyl acrylate, glycidyl methacrylate, or combinations thereof;
the curing agent comprising the ester functional group or the carboxylic acid functional group is derived from an acrylate, a methacrylate, hexahydrophthalic anhydride, methyl hexahydrophthalic anhydride, methyl tetrahydrophthalic anhydride, tetrahydrophthalic anhydride, isophthalate, fatty acid, or combinations thereof; or
combinations thereof.

Embodiment 10. The process of any one of Embodiments 8-9, wherein the cured thermosetting resin matrix is derived from the epoxy resin comprising the ester functional group, and a ratio of ester functional groups to epoxy groups of the epoxy resin comprising the ester functional group is from about 0.05:1 to about 9.5:1.

Embodiment 11. The process of any one of Embodiments 8-10, wherein the cured thermosetting resin matrix comprising one or more ester functional groups is thermally-reformable.

Embodiment 12. The process of any one of the preceding Embodiments, wherein:
the reaction temperature is about 170° C. or less, or about 80° C. to about 200° C.; or
the reaction temperature is greater than a glass transition temperature of the cured thermosetting resin matrix; or
combinations thereof.

Embodiment 13. The process of any one of the preceding Embodiments, wherein the reinforcement material comprises glass, carbon, aramid, thermoplastic fibers, natural fibers, inorganic fillers, metals, or combinations thereof.

Embodiment 14. The process of any one of the preceding Embodiments, wherein after the reacting the reaction mixture and before the isolating the reinforcement material and the isolating the organic liquid composition, at least a portion of the reaction product mixture comprising the degraded residues and the reinforcement material is processed to form: adhesives; coatings; thermoset composites; insulation materials; bulk molding compounds; sheet molding compounds; or combinations thereof.

Embodiment 15. The process of any one of the preceding Embodiments, wherein the isolating the reinforcement material from the reaction product mixture and the isolating the organic liquid composition from the reaction product mixture is performed concurrently or sequentially.

Embodiment 16. The process of any one of the preceding Embodiments, wherein the isolating the reinforcement material from the reaction product mixture, the isolating the organic liquid composition from the reaction product mixture, or both comprises filtration, vacuum filtration, centrifugation, decanting, decanting centrifugation, or combinations thereof, among other techniques.

Embodiment 17. A process for recycling a composite material, the process comprising:
pretreating a composite material comprising reinforcement material and a cured thermosetting resin matrix, the pretreating the composite material comprising:
   comminuting the composite material;
   mixing the composite material with a swelling agent; or
   combinations thereof;
reacting, at a reaction temperature of about 250° C. or less, a reaction mixture comprising an amine and the pretreated composite material to form a reaction product mixture, the amine comprising at least one primary or secondary amine group, the amine being reactive with the cured thermosetting resin matrix at the reaction temperature;
isolating the reinforcement material from the reaction product mixture; and
isolating an organic liquid composition from the reaction product mixture, the organic liquid composition comprising degraded residues produced from the reacting the amine and the cured thermosetting resin matrix.

Embodiment 18. The process of Embodiment 17, wherein:
the comminuting the composite material comprises comminuting the composite material with a shredder, a hammer mill, a grinder, a granulator, or combinations thereof;
the swelling agent comprises water, acid, ester, ether, glycols, alcohols, lactams, lactones, tertiary amines, or combinations thereof; or
combinations thereof.

Embodiment 19. The process of any one of Embodiments 17-18, wherein the isolating the reinforcement material from the reaction product mixture and the isolating the organic liquid composition from the reaction product mixture is performed concurrently or sequentially.

Embodiment 20. The process of any one of Embodiments 17-19, wherein the isolating the reinforcement material from the reaction product mixture, the isolating the organic liquid composition from the reaction product mixture, or both comprises filtration, vacuum filtration, centrifugation, decanting, decanting centrifugation, or combinations thereof, among other techniques.

Embodiment 21. A process for recycling a composite material, the process comprising:
(a) reacting, at a reaction temperature of about 250° C. or less, a reaction mixture comprising an amine and a composite material comprising reinforcement material and a cured thermosetting resin matrix to form a reaction product mixture, the amine comprising at least one primary or secondary amine group, the amine being reactive with the cured thermosetting resin matrix at the reaction temperature;
(b) isolating the reinforcement material from the reaction product mixture;
(c) isolating an organic liquid composition from the reaction product mixture comprising degraded residues produced from the reacting the amine and the cured thermosetting resin matrix; and
(d) performing post-treatment processing of the organic liquid composition, the post-treatment processing comprising:
   performing a liquid-liquid separation on the organic liquid composition;
   introducing an epoxy resin to the organic liquid composition to form adducts with the degraded residues, unreacted amine, or combinations thereof;
   introducing a curing agent and an epoxy resin to the organic liquid composition to form a second cured thermosetting resin matrix, the second cured thermosetting resin matrix different from the cured thermosetting resin matrix of the composite material;
   recycling the organic liquid composition to (a) the reacting the reaction mixture to form the reaction product mixture; or
   combinations thereof.

Embodiment 22. The process of Embodiment 21, wherein the performing the liquid-liquid separation on the organic liquid composition comprises:
separating the unreacted amine from the degraded residues; and
separating the degraded residues into monomers and oligomers.

Embodiment 23. The process of any one of Embodiments 21-22, wherein the process is free of a separation operation between (c) the isolating the organic liquid composition from the reaction product mixture and (d) the performing the post-treatment processing of the organic liquid composition.

Embodiment 24. The process of any one of Embodiments 21-23, further comprising:
washing, and optionally treating, the reinforcement material isolated from the reaction product mixture, the optional treating comprising drying, adding a sizing agent; and
processing the washed, and optionally dried, reinforcement material into a yarn, a woven fabric, a non-woven fabric, pellets, milled pellets, fibers, a second composite material, or combinations thereof.

Embodiment 25. The process of any one of Embodiments 21-24, wherein the isolating the reinforcement material from the reaction product mixture and the isolating the organic liquid composition from the reaction product mixture is performed concurrently or sequentially.

Embodiment 26. The process of any one of Embodiments 21-25, wherein the isolating the reinforcement material from the reaction product mixture, the isolating the organic liquid composition from the reaction product mixture, or both comprises filtration, vacuum filtration, centrifugation, decanting, decanting centrifugation, or combinations thereof, among other techniques.

As is apparent from the foregoing general description and the specific aspects, while forms of the aspects have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method. or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “an epoxy resin” includes aspects comprising one, two, or more epoxy resins, unless specified to the contrary or the context clearly indicates only one epoxy resin is included.

While the foregoing is directed to aspects of the present disclosure, other and further aspects of the disclosure may be devised without departing from the basic scope thereof, and the scope thereof is determined by the claims that follow.

What is claimed is:

1. A process for recycling a composite material, the process comprising:
reacting, at a reaction temperature of about 250° C. or less, a reaction mixture comprising:
an amine; and
a composite material comprising:
a reinforcement material; and
a cured thermosetting resin matrix to form a reaction product mixture, the amine comprising at least one primary or secondary amine group, the amine being reactive with the cured thermosetting resin matrix at the reaction temperature;
isolating the reinforcement material from the reaction product mixture; and
isolating an organic liquid composition from the reaction product mixture, the organic liquid composition comprising degraded residues produced from the reacting the amine and the cured thermosetting resin matrix.

2. The process of claim 1, wherein:
the amine comprises two primary amines;
the amine is a fully saturated acyclic amine, a fully saturated cyclic amine, or combinations thereof; or
combinations thereof.

3. The process of claim 1, wherein a weight ratio of the amine to the composite material is from about 1:1 to about 20:1.

4. The process of claim 1, wherein the amine comprises 2-methylpentane-1,5-diamine, hexane diamine, 1,3-bis(aminomethyl)cyclohexane, triethylene tetramine, isophorone diamine, hexylamine, or combinations thereof.

5. The process of claim 1, wherein the cured thermosetting resin matrix is derived from:
a resin comprising an epoxy resin, a polyester resin, or combinations thereof;
a curing agent; and
an optional reactive diluent.

6. The process of claim 5, wherein:
the epoxy resin is derived from a first compound comprising bisphenol A, bisphenol F, tetraglycidyl-methylenedianiline, terephthalic acid, phthalic acid, hexahydrophthalic acid, halogenated bisphenol, novolac, ortho-aminophenol, para-aminophenol, flourenone bisphenol, dicyclopentadiene, guaiacol, 4-methyl guaiacol, 4-ethyl guaiacol, eugenol, syringol, vanillin, or combinations thereof;
the polyester resin is derived from a second compound comprising an unsaturated ester, a vinyl ester, or combinations thereof;
the curing agent is derived from a third compound comprising an acrylate, a methacrylate, an anhydride, an ester, an amine, a Lewis acid, or combinations thereof;
the optional reactive diluent comprises butanediol, hexanediol, pentaerythritol, glycerin, trimethylolpropane triacrylate, a fatty alcohol, a fatty acid, or combinations thereof; or
combinations thereof.

7. The process of claim 1, wherein:
the degraded residues comprise amide reaction products from reaction of the amine with one or more ester groups present in the cured thermosetting resin matrix;
the degraded residues comprise amine reaction products from reaction of the amine with a C—O bond, a C—N bond, or combinations thereof, of the cured thermosetting resin matrix; or
combinations thereof.

8. The process of claim 1, wherein:
the cured thermosetting resin matrix comprises one or more ester functional groups; and
the cured thermosetting resin matrix comprising one or more ester functional groups is derived from an epoxy resin comprising an ester functional group, a curing agent comprising an ester functional group, a curing agent comprising a carboxylic acid functional group, or combinations thereof.

9. The process of claim 8, wherein:
the epoxy resin comprising the ester functional group is derived from a glycidyl fatty acid ester, diglycidyl ester, a triglycidyl ester, diglycidyl isophthalate, hexahydrophthalic acid diglycidyl ester, hexahydrophthalic anhydride glycidyl ester, 3,4-epoxycyclohexylmethyl-3′,4′-epoxycyclohexane carboxylate, glycidyl acrylate, glycidyl methacrylate, or combinations thereof;
the curing agent comprising the ester functional group or the carboxylic acid functional group is derived from an acrylate, a methacrylate, hexahydrophthalic anhydride, methyl hexahydrophthalic anhydride, methyl tetrahydrophthalic anhydride, tetrahydrophthalic anhydride, isophthalate, fatty acid, or combinations thereof; or
combinations thereof.

10. The process of claim 8, wherein the cured thermosetting resin matrix is derived from the epoxy resin comprising the ester functional group, and a ratio of ester functional groups to epoxy groups of the epoxy resin comprising the ester functional group is from about 0.05:1 to about 9.5:1.

11. The process of claim 8, wherein the cured thermosetting resin matrix comprising one or more ester functional groups is thermally-reformable.

12. The process of claim 1, wherein:
the reaction temperature is from about 80° C. to about 200° C.; or
the reaction temperature is greater than a glass transition temperature of the cured thermosetting resin matrix; or
combinations thereof.

13. The process of claim 1, wherein the reinforcement material comprises glass, carbon, aramid, thermoplastic fibers, natural fibers, inorganic fillers, metals, or combinations thereof.

14. The process of claim 1, wherein after the reacting the reaction mixture and before the isolating the reinforcement material and the isolating the organic liquid composition, at least a portion of the reaction product mixture comprising the degraded residues and the reinforcement material is processed to form: adhesives; coatings; thermoset composites; insulation materials; bulk molding compounds; sheet molding compounds; or combinations thereof.

15. A process for recycling a composite material, the process comprising:
pretreating a composite material comprising reinforcement material and a cured thermosetting resin matrix, the pretreating the composite material comprising:
comminuting the composite material;
mixing the composite material with a swelling agent; or
combinations thereof;
reacting, at a reaction temperature of about 250° C. or less, a reaction mixture comprising an amine and the pretreated composite material to form a reaction product mixture, the amine comprising at least one primary or secondary amine group, the amine being reactive with the cured thermosetting resin matrix at the reaction temperature;
isolating the reinforcement material from the reaction product mixture; and
isolating an organic liquid composition from the reaction product mixture, the organic liquid composition comprising degraded residues produced from the reacting the amine and the cured thermosetting resin matrix.

16. The process of claim 13, wherein the isolating the reinforcement material from the reaction product mixture and the isolating the organic liquid composition from the reaction product mixture is performed concurrently or sequentially.

17. A process for recycling a composite material, the process comprising:
(a) reacting, at a reaction temperature of about 250° C. or less, a reaction mixture comprising an amine and a composite material comprising reinforcement material and a cured thermosetting resin matrix to form a reaction product mixture, the amine comprising at least one primary or secondary amine group, the amine being reactive with the cured thermosetting resin matrix at the reaction temperature;
(b) isolating the reinforcement material from the reaction product mixture;
(c) isolating an organic liquid composition from the reaction product mixture comprising degraded residues produced from the reacting the amine and the cured thermosetting resin matrix; and
(d) performing post-treatment processing of the organic liquid composition, the post-treatment processing comprising:
performing a liquid-liquid separation on the organic liquid composition;
introducing an epoxy resin to the organic liquid composition to form adducts with the degraded residues, unreacted amine, or combinations thereof;
introducing a curing agent and an epoxy resin to the organic liquid composition to form a second cured thermosetting resin matrix, the second cured thermosetting resin matrix different from the cured thermosetting resin matrix of the composite material;
recycling the organic liquid composition to (a) the reacting the reaction mixture to form the reaction product mixture; or
combinations thereof.

18. The process of claim 17, wherein the performing the liquid-liquid separation on the organic liquid composition comprises:
separating the unreacted amine from the degraded residues; and
separating the degraded residues into monomers and oligomers.

19. The process of claim 17, wherein the process is free of a separation operation between (c) the isolating the organic liquid composition from the reaction product mixture and (d) the performing the post-treatment processing of the organic liquid composition.

20. The process of claim 17, wherein the isolating the reinforcement material from the reaction product mixture and the isolating the organic liquid composition from the reaction product mixture is performed concurrently or sequentially.
